(19) United States
(12) Patent Application Publication
(10) Pub. No.: US 2015/0338497 A1
(43) Pub. Date: Nov. 26, 2015

(54) TARGET TRACKING DEVICE USING HANDOVER BETWEEN CAMERAS AND METHOD THEREOF

(71) Applicant: SAMSUNG SDS CO., LTD., Seoul (KR)

(72) Inventors: Ki-Sang KWON, Seoul (KR); Jung-Min KONG, Yongin-si (KR); Mi-Ri KIM, Seoul (KR); Jae-Woong YUN, Bucheon-si (KR)

(73) Assignee: SAMSUNG SDS CO., LTD., Seoul (KR)

(21) Appl. No.: 14/538,463

(22) Filed: Nov. 11, 2014

(30) Foreign Application Priority Data
May 20, 2014 (KR) 10-2014-0060309
Jul. 30, 2014 (KR) 10-2014-0097147

(51) Int. Cl. G01S 3/786

(52) U.S. Cl. CPC G01S 3/7864

(57) ABSTRACT

A target tracking device has an input unit configured to receive information on a target to be searched for, and a predicted path calculating unit configured to use the received information and a plurality of prediction models to calculate a movement candidate point of the target for each of the prediction models so as to provide movement candidate points. The predicted path calculating unit also determines a predicted movement point of the target by making a comparison among the calculated movement candidate points. A determining unit able to determine whether an image of the target is included in imagery of a camera, at one of the movement candidate points, is controlled to first check imagery of a camera at only the predicted movement point of the target.

### CROSS-REFERENCE TO RELATED APPLICATION

This application claims priority to and the benefit of Korean Patent Application Nos. 10-2014-0060309, filed on May 20, 2014, and 10-2014-0097147, filed on Jul. 30, 2014, the disclosures of all which are incorporated herein by reference in their entirety.

### BACKGROUND

1. Field

Embodiments of the present disclosure relate to target tracking technology using an image.

2. Discussion of Related Art

As closed-circuit television (CCTV) and the like have become ubiquitous, video data is increasingly being used to track a suspect's trajectory, a suspect's vehicle, and the like. In a target tracking method used in the related art, in general, an operator manually observes all video data from within a suspected area and during a time zone of concern, with the naked eye, thereby to find a target. However, since such a related art method depends on the subjective determination of the monitor staff, the related art method suffers from problems of limited accuracy, and rapid increases in time and cost as the tracking range increases.

In order to address such problems, various tracking methods in which a specific person and the like are tracked in an image have been proposed in the past. However, since methods in the related art were generally provided to detect whether there is a specific target in one image, it was difficult to effectively track a target from images collected from a plurality of cameras.

### SUMMARY

Embodiments of the present disclosure are provided to effectively decrease the computation amount and computation time when target tracking using a plurality of cameras.

According to an example embodiment, there is provided a target tracking device. The device includes: an input unit configured to receive information on a target to be searched for; a predicted path calculating unit configured to use the received information and a plurality of prediction models to calculate a movement candidate point of the target for each of the plurality of prediction models so as to provide movement candidate points, the predicted path calculating unit being further configured to determine a predicted movement point of the target by making a comparison among the calculated movement candidate points; and a determining unit configured to determine whether an image of the target is included in imagery of a camera at one of the movement candidate points. Concretely this is realized by a computer system implementing one or more of the input unit, the predicted path calculating unit, and the determining unit, the computer system having a processor, a memory under control of the processor, and a storage storing a control program that controls the computer system. Here, imagery of a camera at only the predicted movement point of the target is first checked to determine whether an image of the target is included in the imagery.

According to an example embodiment, the input unit is further configured to receive, as at least part of the information on the target to be searched for, an image of the target, an observation location of the target, a target observation time, and/or a movement direction of the target.

According to an example embodiment, the observation location of the target corresponds to location information of a camera having respective imagery including the image of the target.

According to an example embodiment, for the predicted movement point of the target, location information of the camera at the predicted movement point of the target is used as predicted location information of the target.

In another example embodiment, the predicted path calculating unit is further configured to derive information, on at least one candidate camera associated with at least one of the calculated movement candidate points, thereby providing derived camera information, and to make the comparison among the calculated movement candidate points taking into account the derived camera information.

According to an example embodiment, the predicted path calculating unit is further configured to make the comparison among the calculated movement candidate points based at least in part on a frequency of prediction of the calculated movement candidate points, and at least in part on an application of a predetermined weight of each of the plurality of prediction models.

In another example embodiment, the predicted path calculating unit is further configured use, as ones of the plurality of prediction models, one or more of a hidden Markov model (HMM), a Gaussian mixture mode (GMM), a decision tree, and a location based model.

According to an example embodiment, the predicted path calculating unit is further configured to combine two or more of the plurality of prediction models to provide a hybrid model, and to obtain from the hybrid model one of the movement candidate points.

In another example embodiment, the predicted path calculating unit is further configured to combine two or more of the plurality of prediction models, using a weighted majority voting method in which different weights are applied to the two or more of the plurality of prediction models, to obtain one of the movement candidate points.

According to an example embodiment, when the determining unit determines that the image of the target is not included in the imagery of the camera at the predicted movement point of the target first checked, the predicted path calculating unit responds by performing a reselection to identify a different one of the movement candidate points to be checked second.

Another example embodiment provides for a target tracking method, including receiving information on a target to be searched for; using the received information and a plurality of prediction models to calculate a movement candidate point of the target for each of the plurality of prediction models so as to provide movement candidate points; selecting a predicted movement point of the target by making a comparison among the calculated movement candidate points; and determining whether an image of the target is included in imagery of a camera at one of the movement candidate points, wherein imagery of a camera at only the predicted movement point of the target is first checked to determine whether the image of the target is included in the imagery. The method is implemented by a computer system having a processor, a memory under control of the processor, and a storage storing a control program that controls the computer system.

According to an example embodiment, the information on the target includes an image of the target, and an observation location, an observation time, and/or a movement direction of the target.

The observation location of the target corresponds to location information of a camera having respective imagery including the image of the target, in an example embodiment.

Location information of the camera at the predicted movement point of the target is used as predicted location information of the target, in another example embodiment.

The calculating of the movement candidate points, according to an example embodiment, includes deriving information, on at least one candidate camera associated with at least one of the movement candidate points, thereby providing derived camera information, and wherein the making of the comparison among the calculated movement candidate takes into account the derived camera information.

In another example embodiment, the calculating of the movement candidate points based at least in part on a frequency of prediction of the calculated movement candidate points is performed at least in part based on an application of a predetermined weight of each of the plurality of prediction models.

In one example embodiment, the method includes using, as ones of the plurality of prediction models, one or more of a hidden Markov model (HMM), a Gaussian mixture mode (GMM), a decision tree, and a location based model.

In another example embodiment, the method includes combining two or more of the plurality of prediction models to provide a hybrid model, and obtaining from the hybrid model one of the movement candidate points.

In still another example embodiment, the method includes combining two or more of the plurality of prediction models, using a weighted majority voting method in which different weights are applied to the two or more of the plurality of prediction models, to obtain one of the movement candidate points.

In an example embodiment, the method includes, when the image of the target is not included in the imagery of the camera at the predicted movement point of the target first checked, responding by performing a reselection to identify a different one of the movement candidate points to be checked second.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a configuration of a target tracking device 100 according to an embodiment of the present disclosure;

FIG. 2 is a diagram illustrating an exemplary process of calculating a path in a predicted path calculating unit 104 and a determining unit 106 according to an embodiment of the present disclosure;

FIG. 3 is a diagram illustrating exemplary display of a target tracking result on a screen according to an embodiment of the present disclosure;

FIG. 4 is a flowchart illustrating a target tracking method 300 according to an embodiment of the present disclosure;

FIG. 5 is a state transition diagram illustrating exemplary data modeling for a predicted path calculating unit to apply a hidden Markov model to a target according to an embodiment of the present disclosure; and

FIG. 6 is a diagram illustrating an exemplary direction of a symbol observed in each state of the state transition diagram illustrated in FIG. 5.

### DETAILED DESCRIPTION OF EXEMPLARY EMBODIMENTS

Hereinafter, detailed embodiments of the present disclosure will be described with reference to the drawings. The following detailed description is provided to help give a comprehensive understanding of methods, devices and/or systems described in this specification. However, these are only example embodiments, and the present disclosure is not limited thereto.

In descriptions of the present disclosure, when it is determined that detailed descriptions of related well-known functions unnecessarily obscure the gist of the present disclosure, detailed descriptions thereof will be omitted. Some terms described below are defined by considering functions in the present disclosure and meanings may vary depending on, for example, a user or operator's intentions or customs. Therefore, the meanings of terms should be interpreted based on their scope throughout this specification. The terms used in this detailed description are provided only to describe embodiments of the present disclosure, and not for purposes of limitation. Unless the context clearly indicates otherwise, the singular forms include the plural forms. It will be understood that the terms “comprises” or “includes” when used herein, specify some features, numbers, steps, operations, elements, and/or combinations thereof, but do not preclude the presence or possibility of one or more other features, numbers, steps, operations, elements, and/or combinations thereof in addition to the description. Likewise, combinations described in the context of example embodiments are mentioned for the sake of completeness, even though subcombinations thereof are within the scope and spirit of this disclosure.

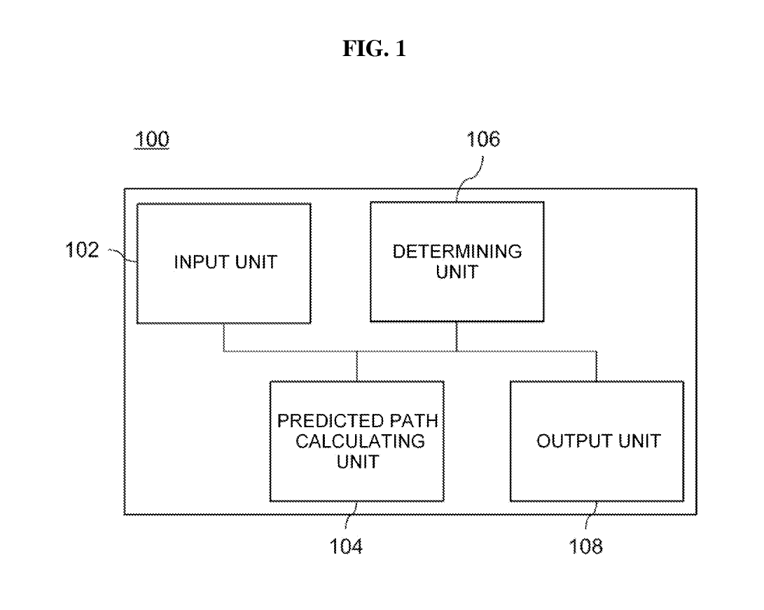

FIG. 1 is a block diagram illustrating a configuration of a target tracking device 100 according to an embodiment of the present disclosure. The target tracking device 100 according to the embodiment of the present disclosure is a device for effectively selecting other cameras that need to be searched for in order to track movement of a target when the target is detected by a specific camera in an area in which a plurality of cameras are installed. The device is a general purpose computer or a special purpose computer, according to example embodiments. According to an example embodiment, the device is implemented as a general purpose computer having a processor such as a CPU, a memory under control of the processor, a storage storing a control program that controls the device and (directly or indirectly) the various components shown in FIG. 1, and a user interface for accepting user inputs and displaying processing results. According to an example embodiment, the device is implemented as a general purpose computer communicating with a plurality of cameras. In an example embodiment, the communication with one or more of the plurality of cameras takes place over a network. In another example embodiment, the communication takes place with other computer systems exercising control over the plurality of cameras and acting as intermediaries in the communication. According to an example embodiment, the device is implemented as a special purpose computer having an ASIC or the like. In general, an area that can be covered by one camera is limited, but a target such as a person or a car continuously moves. Therefore, in order to track movement of the target, it is necessary to continuously observe the target through handovers between cameras in a corresponding area. In one embodiment, the target tracking device 100 is configured to track a specific target using a database (not shown) storing location information of a plurality of cameras in a specific area, and video image data obtained from each camera. The example embodiments of the present disclosure are not necessarily limited thereto. In another embodiment, the specific target may also be tracked in real time using image information received in real time from the plurality of cameras in the specific area. It should be noted that herein a camera refers not only to a physical camera, such as a network camera or a Closed Circuit Television (CCTV) camera, but also a video image captured or obtained by a corresponding camera.

As illustrated, the target tracking device 100 according to an embodiment includes an input unit 102, a predicted path calculating unit 104, a determining unit 106, and an output unit 108.

The input unit 102 receives, from a user, information about a target for which a search is to be performed. The target may be any sort of subject including, but not limited to, a specific person, animal, or. In addition, information about the target (i.e., target information) may include at least one of an image of the target (i.e. a target image), an observation location, an observation time, and a direction of movement of the target. According to an example embodiment, the input unit includes a keyboard, pointing device, stylus, joystick, and the like, together with a user interface adapted to obtain from a user information about the target.

In an embodiment, the user may select an image of the target from one frame of an image imaged by a specific camera in a search target area. The selected image of the target is preferably an image including a distinguishing feature of the target, such as a face or clothes. Therefore, the target is more easily identified during a subsequent target tracking process. For this purpose, the input unit 102, according to an example embodiment, provides a user interface to accept a selection of the target on a screen. The user selects a specific area on the screen through the user interface, and separates the subject in the selected area from its background. The input unit 102 stores the selected image of the target, obtained through the above-mentioned operations, along with information indicating the imaging time and the imaging location (GPS location, and the like) of the corresponding frame, the movement direction of the target in the corresponding image, and the like.

The predicted path calculating unit 104 searches for a point to which the target is predicted to have moved from the initially recognized point. In an example embodiment, the predicted path calculating unit 104 is configured to calculate a movement candidate point of the target, for each prediction model, from the received information using two or more location prediction models, and to determine a predicted movement point of the target by comparing the calculated movement candidate points for each prediction model. In this embodiment, the predicted movement point of the target is the location information of a camera in which it is determined that the target will be found. Also, in an example embodiment, the location information of the camera includes installation information (a field of view, an IP address, image quality, installation location, and the like) of the camera, product information (the name of the manufacturer, model name, specifications, and the like) of the camera, and camera type information (e.g., fixed camera, Pan-Tilt-Zoom (PTZ), infrared capability, and the like). Details thereof will be described in greater detail below.

The predicted path calculating unit 104, according to an example embodiment, includes algorithm models that calculate the predicted movement point of the target from information on the target obtained in the input unit 102. Also, in an embodiment, the predicted path calculating unit 104 is configured as a hybrid model including two or more location prediction models. The hybrid model can obtain a result having higher reliability and accuracy than a result obtained using only one location prediction model.

Examples of the algorithm models include a statistics-based method such as a hidden Markov model (HMM), a Gaussian mixture model (GMM), a decision tree, a simple location-based model. The example embodiments are not limited to a specific algorithm model. The predicted path calculating unit 104, in an example embodiment, is configured to use an algorithm model selected from among the above-described algorithm models. The selection of the particular algorithm model is based on the movement direction pattern, etc. of a tracking target. In this example embodiment, the selection of the algorithm models may change in accordance with a learning result so as to become a model that is robust to different movement direction patterns.

The hidden Markov model (HMM) is a statistics-based prediction model in which a subsequent location of the target is predicted from sequential data, based on time series data. Therefore, when a pedestrian moves to a specific point and has a walking movement pattern in consideration of a shortest distance to a destination, the result predicted by the HMM may accurately predict the actual movement direction of the pedestrian.

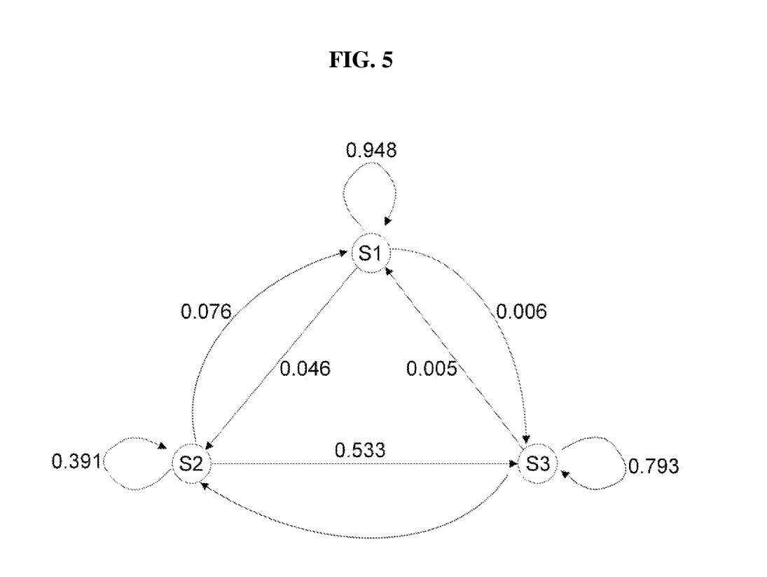

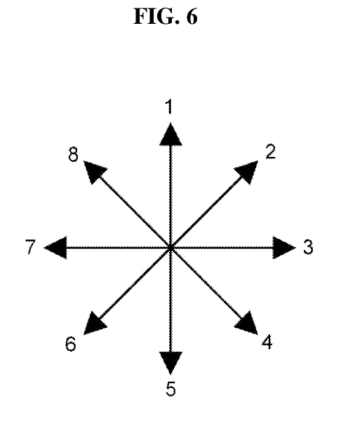

FIG. 5 is a state transition diagram illustrating exemplary data modeling for the predicted path calculating unit to apply the HMM to the target according to an example embodiment. The illustrated state transition diagram is generated by learning pedestrian trajectory data that includes GPS coordinates transmitted from the pedestrian at the intervals of 5 seconds. In other words, the pedestrian trajectory data may be obtained by empirical study. Three states S1, S2, and S3 are found in the learning result obtained in this example. An arrow is a probability of transitioning from a given state to the next state or a probability of indicating the same state. A symbol observed in each state has 8 directions as illustrated in FIG. 6, and a probability of the symbol to be observed in each state, determined from the learning result obtained in this example study, is shown in Table 1.

TABLE 1

| | S1 | S2 | S3 |
|---|---|---|---|
| P(O₁) | 0.478 | 0.991 | 1.000 |
| P(O₂) | 0.166 | 0.004 | 0.000 |
| P(O₃) | 0.044 | 0.000 | 0.000 |
| P(O₄) | 0.028 | 0.000 | 0.000 |
| P(O₅) | 0.036 | 0.000 | 0.000 |
| P(O₆) | 0.028 | 0.000 | 0.000 |
| P(O₇) | 0.044 | 0.000 | 0.000 |
| P(O₈) | 0.174 | 0.004 | 0.000 |

GMM is a statistics-based prediction model in which each normal distribution of different movement directions to be observed in each state is generated and the next location is predicted based thereon. Since a normal distribution of each state is not influenced by a previous state, this model is more appropriate than the HMM for predicting a case in which the target rapidly changes its direction or shows an irregular moving pattern.

Each of location prediction algorithm models has its own features, advantages, and disadvantages. Therefore, when using a hybrid model in which a plurality of algorithm models are combined, it is possible to distribute bias and overcome the limitation of a local optimum. Also, the more accurate result is obtained compared with the result from using only one algorithm model. Several voting methods may be used for combining or selecting algorithm results in a hybrid model. For example, a simple majority voting method or a weighted majority voting method which assigns different weights to each model can be applied. As described above, since some algorithm models are more appropriate than others, depending on the features or specific moving pattern of the target, different weights can be assigned accordingly. For example, the predicted path calculating unit 104 may combine the hybrid model through an Adaboost method (Adaboost is a boosting method). When the Adaboost method is used, according to an example embodiment, the algorithm models can have complementary results according to the features of the target such as its moving pattern.

The predicted path calculating unit 104, according to an example embodiment, calculates at least one candidate point for each algorithm by providing information about the target to each algorithm model, and determining a prediction point, at which the target will be searched for. The prediction point is selected through comparison of, or competition among, the calculated candidate points generated by the various algorithms.

In an example embodiment, the predicted path calculating unit 104 selects at least one camera for searching the target based on a prediction frequency (the number of times each camera is selected by each of the prediction models). Also, depending on embodiments, the weight for each prediction model is considered, along with the prediction frequency, to select the camera. In other words, the predicted path calculating unit 104, in an example embodiment, determines a candidate point, in which the target will be searched, through voting on candidate points according to the prediction result of each algorithm model. For example, assume that there are six cameras 1 to 6 adjacent to a camera of a point in which the target is currently found. Further, in this example, there are three different algorithm models. Here, algorithm model 1 predicts as candidate points cameras 1, 3, and 5. Algorithm model 2 predicts as candidate points cameras 3, 5, and 6. Algorithm 3 predicts as candidate points cameras 4, 5, and 6. In this case, since the camera 5 has the highest number of 3 votes among the six cameras, the predicted path calculating unit 104 preferentially determines the point (camera) 5 is the next predicted movement point of the target.

In another embodiment, the predicted path calculating unit 104 determines the predicted movement point of the target from candidate points derived from each algorithm model based on a majority rule. For example, when two algorithms select the camera 3 as an optimal candidate point and one algorithm selects the camera 2 as an optimal candidate point in the above example, the camera 3 may be selected as the predicted movement point of the target based on the majority rule.

In still another embodiment, the predicted path calculating unit 104 uses a result obtained by prior learning, using training data, and assigns a weight for each event type (e.g., a crime or the like) to each candidate point. Specifically, the training data in this example embodiment is obtained when a separate tester holds a GPS transmitter or the like, moves among camera candidate points, and transmits collected data to a collecting server at specific intervals. Different categories may be generated for such training data according to event type attributes, e.g., according to criminal tendencies. As an example, when a crime scenario targeting a large number of people, such as a terrorism scenario in which a bomb treat is considered, the tester may move to a square or a facility in which a lot of people are gathered, and generate data. In another example, when a crime scenario targeting a specific person, such as a scenario in which a robbery or a rape is considered, the tester may move to an unfrequented street or an area in which bars and clubs are concentrated, and generate data. Basic information of such data, according to an example embodiment, includes latitude and longitude coordinates, a calling time, and the like. In addition, in an example embodiment, features of criminals such as they type of clothing they tend to wear, based on profiling or the like, is included as additional information. In this example embodiment, when applying weights according to the type of crime type, it is possible to more accurately select the next predicted movement point of the target.

Additionally, according to another example embodiment, the predicted path calculating unit 104 may apply various elements such as accuracy for each algorithm in a previous operation, a weight for each algorithm according to features of the target, and the like, and predict movement of the target from the candidate point derived for each algorithm. For example, when the target is a criminal, according to an example embodiment, a number of target-related predictions are made, such as that the criminal target tends to (1) intentionally move into crowds to avoid investigation, (2) prefer shopping centers, subways, and the like so as to consider further crimes, and (3) generally avoid government offices such as police stations, fire stations, and the like. Similarly, according to another example embodiment, when the target is a missing child, the target-related predictions include that the missing child target (1) tends to intentionally move to nearby government offices such as police stations, fire stations, and the like and (2) is unlikely to use intercity transportation. That is, when a weight is assigned to a specific point such as a transportation facility, a government office, and a shopping center located in the vicinity of a candidate search point, assigning the weight based on the type of target, and on the corresponding target-related predictions, much higher accuracy in candidate selection may be expected. In other words, embodiments of the present disclosure are not limited to a specific method of deriving a final conclusion from results obtained by the plurality of algorithms, but may use a method without limitation, as long as the method derives a final conclusion from a plurality of result values obtained by the plurality of algorithms such as frequency, weight, and priority as described above. That is, in the embodiment of the present disclosure, it should be understood that “comparison” of result values obtained by each algorithm includes all operations of deriving a final conclusion from a plurality of different result values.

Also, the predicted path calculating unit 104 does not necessarily select one prediction point (camera), but may select a group of a plurality of cameras in an area to which the target is predicted to have moved or select a predicted path in which a plurality of cameras are sequentially connected.

The determining unit 106 determines whether the target is in an image obtained from at least one camera selected in the predicted path calculating unit 104. According to an example embodiment, when the target is a person, the determining unit 106 determines whether a face similar to that of the target is found in the image using a face recognition algorithm. In this example embodiment, the face recognition is robust to an outdoor environment. In particular the face recognition algorithm has a high detection and recognition rate in various outdoor environment conditions (i.e., takes into account changes in colors, lighting, time of day), and preferably handles changes in angles, partial occlusions, postures, and the like, and has the capability to perform a partial face match. Also, in addition to face recognition, in an example embodiment, as a method of increasing the accuracy of detecting a similar target, a feature of the person is considered such as size information, color information, rate information, and the like.

When it is determined that there is no target in the image obtained from the camera selected first, the predicted path calculating unit 104 may select a different camera in which it is predicted that the target will be found based on the information on the derived candidate camera other than the camera selected first. For example, when the predicted path calculating unit 104 selects a camera by voting of algorithms, if it is determined that the target is not detected in the selected camera, the predicted path calculating unit 104 may select a camera that is second most selected by algorithms (in the above example, camera 3 or camera 6).

On the other hand, when the target is actually found from the camera of the prediction point based on the determination result of the determining unit 106, the predicted path calculating unit 104 searches for the predicted movement point of the target again based on the newly found camera. This operation is repeated until an initially set time range or area range is reached or there are no more candidates searched as the suspect. By connecting predicted movement points derived from the search result, it is possible to derive a predicted movement path of the target.

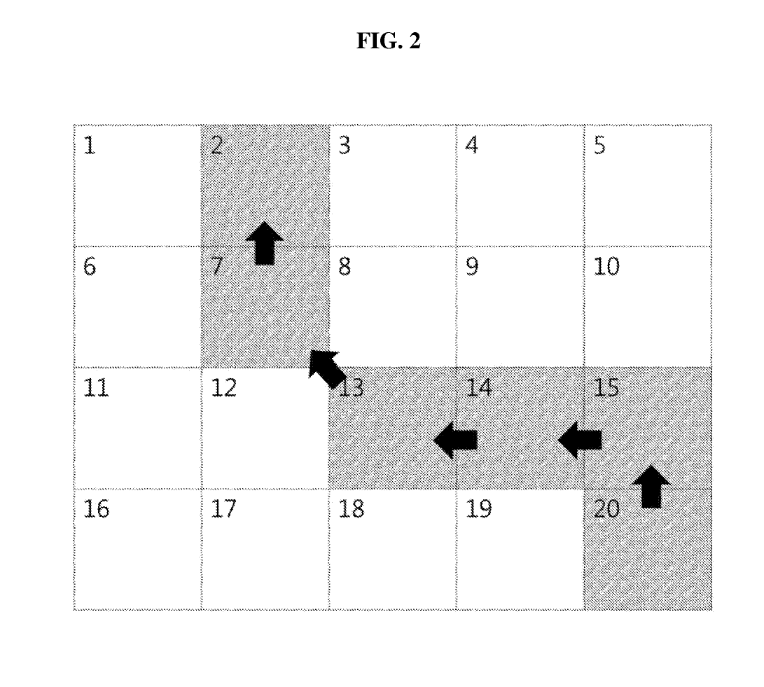

FIG. 2 is a diagram illustrating an exemplary process of calculating a path using the predicted path calculating unit 104 and the determining unit 106 according to an embodiment of the present disclosure. As illustrated, it is assumed that twenty cameras (cameras 1 to 20) are disposed and the target is initially found in camera 20. In this case, the predicted path calculating unit 104 uses a plurality of different algorithms (for example, 3) and calculates a next candidate point in which the target will be found for each algorithm. It is assumed that two algorithms select camera 15 and the remaining one algorithm selects camera 14. In this case, the determining unit 106 selects the camera 15 predicted by two algorithms as a next point and searches the image of the camera for the target. When the target is found in the camera 15 from the search result, the predicted path calculating unit 104 calculates a new candidate point based on the camera 15, and the determining unit 106 selects one point from among the candidate points nominated by the three algorithms. Shaded sections in the illustrated diagram indicate cameras in which the target is found according to a search result obtained by the above operation and arrows indicate a trajectory of the target that is generated by connecting cameras.

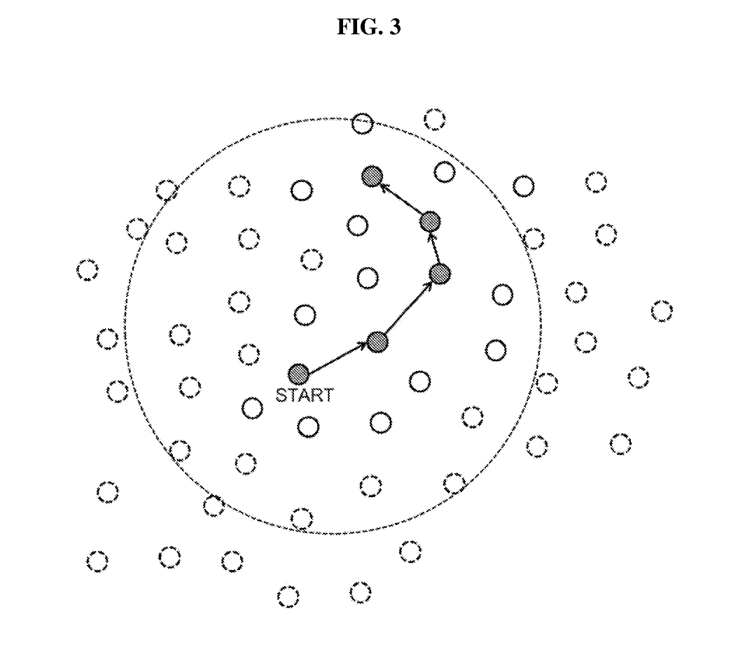

The output unit 108 displays the trajectory of the target calculated by the predicted path calculating unit 104 and the determining unit 106 on a screen. According to an example embodiment, the output unit 108 comprises control logic for controlling a monitor or computer screen to output a visible display for viewing by a user. According to an example embodiment, the output unit 108 also comprises the controlled monitor or computer screen. In an example embodiment, as illustrated in FIG. 3, the output unit 108 is configured to provide information necessary for the user such as outputting the trajectory calculated by the predicted path calculating unit 104 and the determining unit 106 on a map or reproducing the image in which the target is found for each point according to the user's selection. In the illustrated embodiment, a dotted line indicates a location of the camera in a region of interest, a solid line indicates a candidate point for each algorithm, a section etched in an oblique line indicates an actually selected predicted movement point, and a large circle in the center indicates a predetermined time range (for example, within 2 hours from an initial finding time) or an area range.

According to the example embodiments of the present disclosure, there is no need to search every camera in a specific area in order to find the trajectory of the target. In addition, in example embodiments, the target is searched for in only the selected candidate point at any given time. Therefore, it is possible to significantly decrease the amount of computation and time in target tracking.

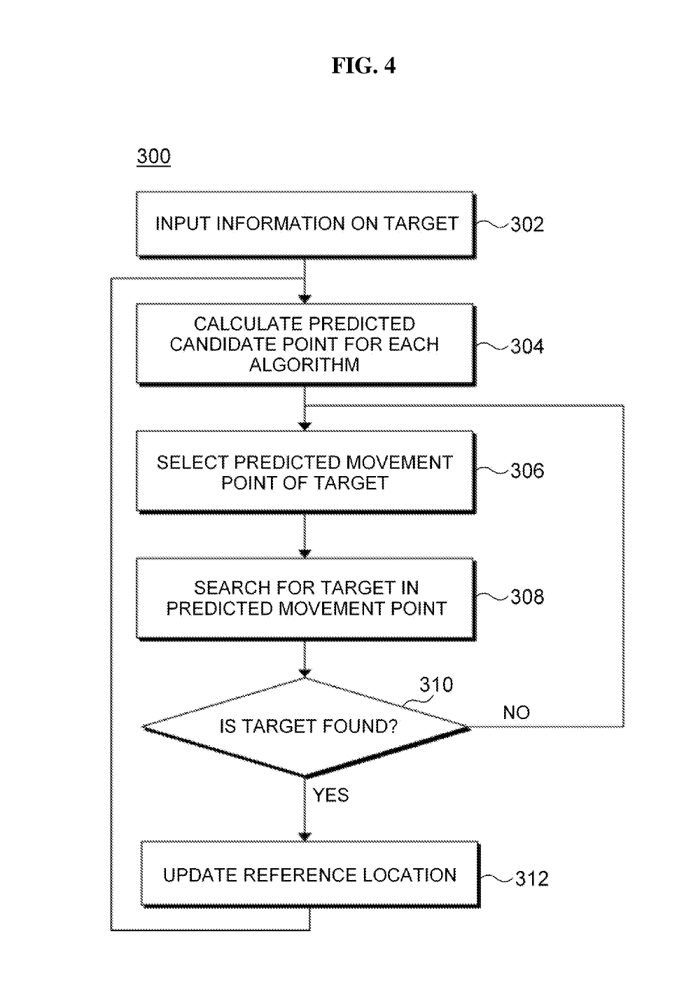

FIG. 4 is a flowchart illustrating a target tracking method 300 according to an example embodiment.

In operation 302, the input unit 102 receives information on the target to be searched for. The information on the target, according to example embodiments, includes an image of the target, an observation location, an observation time, and/or a movement direction of the target. According to an example embodiment, the observation location of the target is the location information of the camera that has captured the target.

In operation 304, the predicted path calculating unit 104 uses two or more location prediction models and calculates a movement candidate point of the target for each prediction model, from the received information.

In operation 306, the predicted path calculating unit 104 determines a predicted movement point of the target by comparing movement candidate points for each prediction model calculated in the operation 304. In example embodiments, the predicted movement point of the target is location information of the camera in which it is determined that the target will be found. That is, in the operation 304, information on at least one candidate camera in which it is determined that the target will be found is derived from each of the two or more location prediction models. In the operation 306, the derived candidate camera information is compared and at least one camera in which it is predicted that the target will be found is selected. As described above, in the operation 306, in an example embodiment, at least one camera in which it is predicted that the target will be found is selected based on a frequency that the candidate camera is selected from each prediction model.

In operation 308, the determining unit 106 searches the image obtained from the selected at least one camera for the target.

In operation 310, the determining unit 106 determines whether the target is in the image based on the search result in the operation 308. When it is determined that the target is not in the image, the determining unit 106 returns to the operation 306 and selects the predicted movement point of the target again from the other movement candidate points for each algorithm. In this case, the initially selected point is excluded from the selection.

On the other hand, when it is determined that the target is in the image, the predicted path calculating unit 104 updates a newly searched point as a reference location (operation 312), and repeats the process from the operation 304 from the updated reference location. The above process is repeated until an initially set time range or area range is reached or there are no more candidates to be searched for the target.

According to example embodiments of the present disclosure, when a plurality of cameras are used to track a target in a specific area, only imagery a camera at a point to which the target is predicted to have moved is searched, rather than searching all the camera imagery of a corresponding area. Therefore, it is possible to significantly decrease the computation amount and time in searching for the target. To put it another way, implementing the example embodiments described above provide for reduced processing resources, namely, reduced CPU cycles and reduced CPU resource usage of the processor when searching for the target, and reduced memory requirements when searching for the target, and also reduced use of personnel resources.

Meanwhile, concretely, an example embodiment includes a computer readable recording medium including a program for executing methods described in this specification in a computer. The computer readable recording medium may include a program instruction, a local data file, and a local data structure, and/or combinations thereof. The medium may be specially designed and prepared for the present disclosure or a generally available medium. Examples of a computer readable recording medium include magnetic media such as a hard disk, a floppy disk, and a magnetic tape, optical media such as a CD-ROM and a DVD, magneto-optical media such as a floptical disk, and a hard device such as a ROM, a RAM, and a flash memory, that is specially made to store and perform the program instruction. Non-limiting examples of the program instruction include firmware, machine code generated by a compiler, and high-level language code that can be executed in a computer using an interpreter.

While the present disclosure has been described above in detail with reference to representative example embodiments, it may be understood by those skilled in the art that the example embodiments may be variously modified without departing from the scope of the present disclosure. Therefore, the scope of the present disclosure is defined not by the described embodiment but by the appended claims, and encompasses equivalents as well.

What is claimed is:

1. A target tracking device, comprising:
an input unit configured to receive information on a target to be searched for;
a predicted path calculating unit configured to use the received information and a plurality of prediction models to calculate a movement candidate point of the target for each of the plurality of prediction models so as to provide movement candidate points, the predicted path calculating unit being further configured to determine a predicted movement point of the target by making a comparison among the calculated movement candidate points;
a determining unit configured to determine whether an image of the target is included in imagery of a camera at one of the movement candidate points;
a computer system implementing one or more of the input unit, the predicted path calculating unit, and the determining unit, the computer system comprising a processor, a memory under control of the processor, and a storage storing a control program that controls the computer system;
wherein imagery of a camera at only the predicted movement point of the target is first checked to determine whether an image of the target is included in the imagery.

2. The device according to claim 1, wherein the input unit is further configured to receive, as at least part of the information on the target to be searched for, at least one of an image of the target, an observation location of the target, a target observation time, and a movement direction of the target.

3. The device according to claim 2, wherein the observation location of the target corresponds to location information of a camera having respective imagery including the image of the target.

4. The device according to claim 1, wherein, for the predicted movement point of the target, location information of the camera at the predicted movement point of the target is used as predicted location information of the target.

5. The device according to claim 1, wherein the predicted path calculating unit is further configured to derive information, on at least one candidate camera associated with at least one of the calculated movement candidate points, thereby providing derived camera information, and to make the comparison among the calculated movement candidate points taking into account the derived camera information.

6. The device according to claim 5, wherein the predicted path calculating unit is further configured to make the comparison among the calculated movement candidate points based at least in part on a frequency of prediction of the calculated movement candidate points, and at least in part on an application of a predetermined weight of each of the plurality of prediction models.

7. The device according to claim 5, wherein the predicted path calculating unit is further configured use, as ones of the plurality of prediction models, one or more of a hidden Markov model (HMM), a Gaussian mixture mode (GMM), a decision tree, and a location based model.

8. The device according to claim 5, wherein the predicted path calculating unit is further configured to combine two or more of the plurality of prediction models to provide a hybrid model, and to obtain from the hybrid model one of the movement candidate points.

9. The device according to claim 5, wherein the predicted path calculating unit is further configured to combine two or more of the plurality of prediction models, using a weighted majority voting method in which different weights are applied to the two or more of the plurality of prediction models, to obtain one of the movement candidate points.

10. The device according to claim 5, wherein, when the determining unit determines that the image of the target is not included in the imagery of the camera at the predicted movement point of the target first checked, the predicted path calculating unit responds by performing a reselection to identify a different one of the movement candidate points to be checked second.

11. A target tracking method, comprising:
receiving information on a target to be searched for;
using the received information and a plurality of prediction models to calculate a movement candidate point of the target for each of the plurality of prediction models so as to provide movement candidate points;
selecting a predicted movement point of the target by making a comparison among the calculated movement candidate points; and
determining whether an image of the target is included in imagery of a camera at one of the movement candidate points, wherein imagery of a camera at only the predicted movement point of the target is first checked to determine whether the image of the target is included in the imagery;
wherein at least one of the receiving, the calculating, the selecting, and the determining steps are implemented by a computer system comprising a processor, a memory under control of the processor, and a storage storing a control program that controls the computer system.

12. The method of claim 11, wherein the information on the target includes at least one of an image of the target, and an observation location, an observation time, and a movement direction of the target.

13. The method of claim 11, wherein the observation location of the target corresponds to location information of a camera having respective imagery including the image of the target.

14. The method of claim 11, wherein location information of the camera at the predicted movement point of the target is used as predicted location information of the target.

15. The method of claim 11, wherein the calculating of the movement candidate points includes deriving information, on at least one candidate camera associated with at least one of the movement candidate points, thereby providing derived camera information, and wherein the making of the comparison among the calculated movement candidate takes into account the derived camera information.

16. The method of claim 15, wherein the calculating of the movement candidate points based at least in part on a frequency of prediction of the calculated movement candidate points is performed at least in part based on an application of a predetermined weight of each of the plurality of prediction models.

17. The method of claim 15, further comprising using, as ones of the plurality of prediction models, one or more of a hidden Markov model (HMM), a Gaussian mixture mode (GMM), a decision tree, and a location based model.

18. The method of claim 15, further comprising combining two or more of the plurality of prediction models to provide a hybrid model, and obtaining from the hybrid model one of the movement candidate points.

19. The method of claim 15, further comprising combining two or more of the plurality of prediction models, using a weighted majority voting method in which different weights are applied to the two or more of the plurality of prediction models, to obtain one of the movement candidate points.

20. The method of claim 15, further comprising, when the image of the target is not included in the imagery of the camera at the predicted movement point of the target first checked, responding by performing a reselection to identify a different one of the movement candidate points to be checked second.
